(19) United States
(12) Patent Application Publication
(10) Pub. No.: US 2026/0065387 A1
(43) Pub. Date: Mar. 5, 2026

(54) PROJECT MANAGEMENT IN A MATERIAL ALLOCATION SYSTEM

(71) Applicant: T-MOBILE INNOVATIONS LLC, Overland Park, KS (US)

(72) Inventor: Stephen Matthew JONES, Allen, TX (US)

(21) Appl. No.: 18/823,392

(22) Filed: Sep. 3, 2024

(51) Int. Cl. G06Q 50/08; G06Q 10/0631

(52) U.S. Cl. CPC G06Q 50/08; G06Q 10/06313

(57) ABSTRACT

Embodiments of the present disclosure are directed to systems and methods for generating project management attributes within a material allocation system for building a new telecommunications cell site. In order to generate project management attributes within a material allocation system, a project management engine of a network processes a database to determine a design of a new cell site, to communicate to third parties messages seeking approvals to begin construction of the new cell site, to determine resources that are required to complete construction of the new cell site, and to generate responses to queries related to the construction of the new cell site. In order to accomplish this, neural networks are used in conjunction with a generative artificial intelligence.

### SUMMARY

The present disclosure is directed to generating project management attributes within a material allocation system, substantially as shown and/or described in connection with at least one of the Figures, and as set forth more completely in the claims.

According to various aspects of the technology, a project management engine of a network processes a database to determine a design of a new cell site, to communicate to third parties messages seeking approvals to begin construction of the new cell site, to determine resources that are required to complete construction of the new cell site, and to generate responses to queries related to the construction of the new cell site. In order to accomplish this, neural networks are used in conjunction with a generative artificial intelligence (AI). A neural network is used to process input data and output when the cell site can be built, where the cell site should be built for the most benefit, and how the cell site should be built to minimize cost and maximize efficiency. Large amounts of data are collected, such as any piece of data associated with the building of a cell site, including the design and the materials necessary to achieve the design, then the neural network may automate sending messages to acquire the approvals required to execute the design and start construction according to the approved design. Furthermore, the neural network may determine what material is available, what other material is still needed, what inventory has been used (e.g., if construction has begun), and any other aspect associated with the materials and resources needed to construct the new cell site. In some aspects, the generative AI processes the data associated with the determinations made by the neural network (e.g., the design of the cell site, the approvals to begin construction, and the resources required for construction), and the generative AI may generate responses to queries related to the construction process of the new cell site. In this way, the workflow of constructing a new cell site may be automated into one singular workflow to improve efficacy and efficiency.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a project management engine in which implementations of the present disclosure may be employed;

FIG. 3 illustrates a design component of the project management engine in which implementations of the present disclosure may be employed;

FIG. 4 illustrates an approval component of the project management engine in which implementations of the present disclosure may be employed;

FIG. 5 illustrates an allocation component of the project management engine in which implementations of the present disclosure may be employed;

FIG. 6 illustrates an interface component of the project management engine in which implementations of the present disclosure may be employed; and

FIG. 7 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz-3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, building a telecommunications cell site involves several crucial steps. It begins with a thorough site assessment, including surveys, geotechnical analysis, and environmental impact evaluations to secure necessary permits and approvals. Planning the site layout is essential, covering access roads, equipment placement, power and data connections, and safety measures. Infrastructure development includes constructing access roads, installing fencing and security systems, and setting up temporary facilities for equipment and personnel. Logistics involve managing the delivery and installation of telecommunications equipment and handling waste responsibly. Construction progresses through site preparation, foundation work, equipment installation, and site finishing. Ensuring safety and regulatory compliance is critical, requiring proper training, adherence to standards, and routine inspections. Effective project management ensures the project stays on schedule and within budget, leading to site cleanup, final inspections, and handover to the telecommunications provider.

Conventionally, determining when, where, and how to build a cell site is manually completed by humans. Employees are manually creating bills of materials (BOMs) (i.e., a precise list of all items to make a product) and using labor hours to approve and allocate resources as needed. This takes hundreds of labor hours per week and has a large margin of error. In other words, big companies expend significant resources on materials and man power to facilitate the construction of new cell sites. A big issue with this manual process is that the people working on the construction projects often do not communicate effectively with each other. As such, a lot of human interaction falls through the cracks, where a worker passes off one task to another worker, who passes the same task to the next person, and to the next person, and so on, losing important insights along the way and significantly delaying the construction process. While the conventional solution to constructing a new site is primarily facilitated by human interaction, a lot of this human interaction can be automated into one singular workflow to improve efficacy and efficiency.

Unlike conventional solutions, the present disclosure is directed to an automated workflow for construction project management. In order to accomplish this, neural networks are used in conjunction with a generative artificial intelligence (AI). A neural network is used to process input data and output when the cell site can be built, where the cell site should be built for the most benefit, and how the cell site should be built to minimize cost and maximize efficiency. Here, large amounts of data are collected, such as any piece of data associated with the building of a cell site, including the design and the materials necessary to achieve the design, then the neural network may automate acquiring all of the approvals required to execute the design and start construction according to the approved design. In some examples, the neural network sends automated emails to third parties to obtain approvals to build the designed cell site. Furthermore, the neural network determines what material is available (e.g., what materials are in inventory), what other material is still needed, what inventory has been used (e.g., if construction has begun), and any other aspect associated with the materials and resources needed to construct the new cell site. In some aspects, the generative AI processes the data associated with the determinations made by the neural network (e.g., the design of the cell site, the approvals to begin construction, and the resources required for construction), and the generative AI may generate responses to queries related to the construction process of the new cell site. In this way, the workflow of constructing a new cell site may be automated, unlike conventional solutions.

Accordingly, a first aspect of the present disclosure is directed to a system for generating project management attributes within a material allocation system. The system comprises one or more base stations receiving a measurement from each of a plurality of connections and aggregating the measurements to form a database within a wireless communications network to detect areas of relative service weakness. The system further comprises one or more computer processing components configured to perform operations comprising determining a design of a new cell site based on data stored in the database. The operations further comprise communicating to one or more third parties at least one message seeking one or more approvals to begin construction of the new cell site. The operations further comprise determining a plurality of resources that are required to complete construction of the new cell site based on data stored in the database. The operations further comprise generating one or more responses to one or more queries related to the construction of the new cell site, the one or more responses based on data stored in the database.

A second aspect of the present disclosure is directed to a method for generating project management attributes within a material allocation system. The method comprises determining a design of a new cell site based on one or more base stations receiving a measurement from each of a plurality of connections and aggregating the measurements to form a database within a wireless communications network to detect areas of relative service weakness. The method further comprises communicating to one or more third parties at least one message seeking one or more approvals to begin construction of the new cell site. The method further comprises determining a plurality of resources that are required to complete construction of the new cell site based on data stored in the database. The method further comprises generating one or more responses to one or more queries related to the construction of the new cell site, the one or more responses based on data stored in the database.

Another aspect of the present disclosure is directed to a non-transitory computer readable media having instructions stored thereon that, when executed by one or more computer processing components, cause the one or more computer processing components to perform a method for generating project management attributes within a material allocation system. The method comprises determining a design of a new cell site based on one or more base stations receiving a measurement from each of a plurality of connections and aggregating the measurements to form a database within a wireless communications network to detect areas of relative service weakness. The method further comprises communicating to one or more third parties at least one message seeking one or more approvals to begin construction of the new cell site. The method further comprises determining a plurality of resources that are required to complete construction of the new cell site based on data stored in the database. The method further comprises generating one or more responses to one or more queries related to the construction of the new cell site, the one or more responses based on data stored in the database.

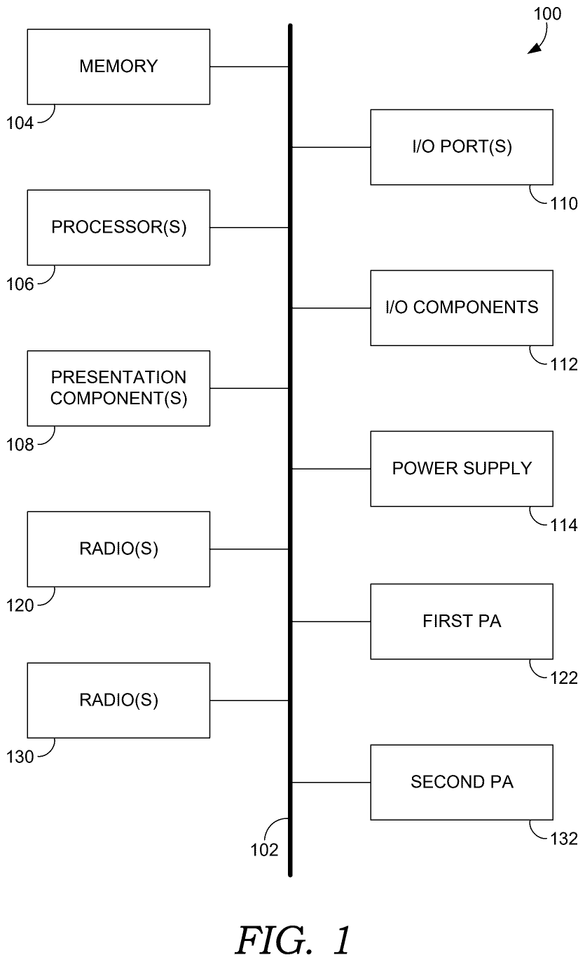

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc.

Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

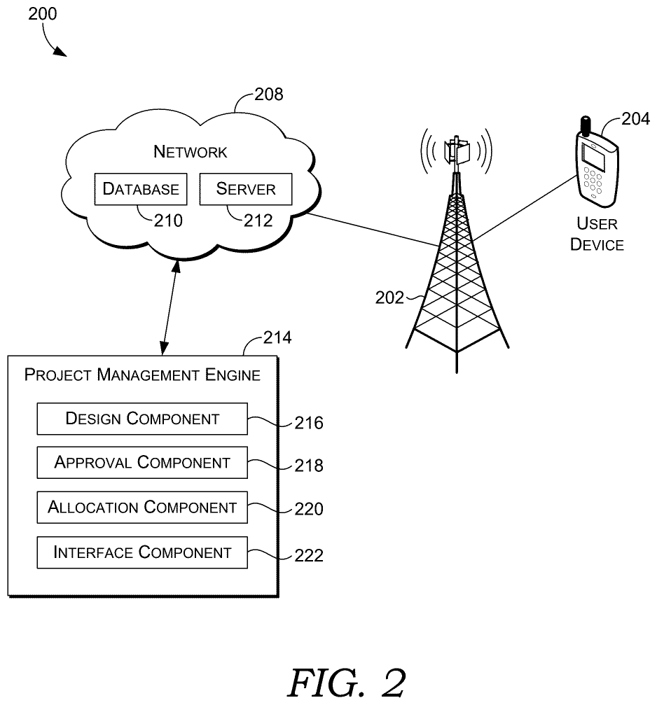

Turning now to FIG. 2, an exemplary network environment is illustrated in which implementations of the present disclosure may be employed. Such a network environment is illustrated and designated generally as network environment 200. At a high level, the network environment 200 comprises one or more UEs, one or more base stations, and one or more networks. Though a UE 204 is illustrated as a cellular phone, a UE suitable for implementations with the present disclosure may be any computing device having any one or more aspects described with respect to FIG. 1. Similarly, a base station 202 is illustrated as a macro cell on a cell tower, any scale or form of access point acting as a transceiver station for wirelessly communicating with a UE, including small cells, pico cells, Wi-Fi access points (e.g., routers or mesh networks), and the like, are suitable for use with the present disclosure.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells, which may or may not overlap. Using any radio access technology selected by a mobile network operator (e.g., 4G, 5G, 6G, 802.11x, and the like), the base station may transmit and receive wireless signals using one or more antenna elements.

Each base station of the one or more base stations may be associated with one or more at least partially distinct networks, wherein each network is associated with one or more network identifiers. Each network, such as network 208, may be a telecommunications network(s) (e.g., a packet data network or core network), data network, or portions thereof. In some examples, the network 208 may comprise a server 212 to manage network performance. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In order to generate project management attributes within a material allocation system, the network environment comprises a project management engine 214. Though illustrated as a dedicated engine comprising four discrete components, the project management engine 214 and its components are described herein by way of their functionality and may be deployed or implemented in various ways that are consistent with the functionality described herein. For example, the project management engine 214 may take the form of one or more computer processing components at or near the base station 202 executing computer executable instructions that cause the one or more computer processing components to perform the operations described herein. The project management engine 214 may be said to comprise a design component 216, an approval component 218, an allocation component 220, and an interface component 222.

The design component 216 is configured to determine a design of a new cell site based on data stored in a database, such as database 210. In some aspects, the design component 216 is a neural network. Relevant to the present disclosure, the design component 216 determines a design of a new cell site based on the population of a given area, the estimated return on investment (ROI), the cost of the construction, and a number of other factors relevant to the construction of a new cell site. In some examples, the design component 216 may determine when a cell site should be built, where the cell site should be built, and how the cell site should be built to minimize cost and maximize efficiency (e.g., ROI).

The approval component 218 communicates to one or more third parties at least one message seeking one or more approvals to begin construction of a new cell site. In some aspects, the approval component 218 is a neural network. In some examples, the approval component 218 automates the gathering of approvals from third parties (e.g., sources that approve or deny the construction of a new cell site). In some embodiments, the approval component 218 applies some sort of threshold to determine whether a message should be sent.

The allocation component 220 determines a plurality of resources that are required to complete the construction of a new cell site based on data stored in the database 210. In some aspects, the allocation component 220 is a neural network. In some examples, the allocation component 220 may analyze current inventory, determine what inventory needs to be fulfilled, and what materials must be acquired. As such, the allocation component 220 analyzes and processes inventory and resources that are required for construction of a new cell site.

The interface component 222 generates one or more responses to one or more queries related to the construction of a new cell site. In some examples, the one or more responses are based on data stored in the database 210. In some aspects, the interface component 222 is a generative artificial intelligence (AI). In some embodiments, the interface component 222 may generate responses to queries regarding the status of the construction of the cell site.

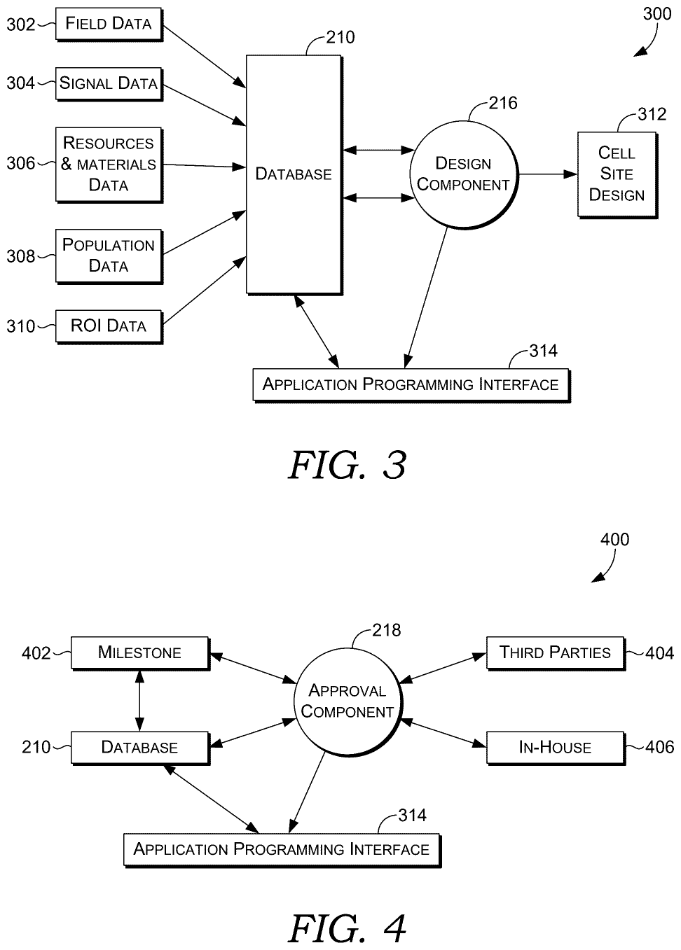

Turning now to FIG. 3, an example of a design component system 300 is provided. The design component system visually illustrates the design component 216 determining a design of a new cell site (e.g., a cell site design 312) based on data stored in the database 210. In some embodiments, the database 210 is a standalone database that is used only by the project management engine 214 to generate project management attributes within a material allocation system. In some aspects, the database 210 may be a database that is shared with other systems to accomplish more tasks within the scope of this disclosure and/or outside the scope of this disclosure. The design component 216 may store the data associated with a cell site design 312 in the database 210.

In some aspects, the design component 216 is a neural network that holistically analyzes the information stored in the database 210 to make determinations regarding operations and designs of a new cell site to efficiently build the new cell site. In order to make those determinations, the database 210 must process information relevant to the potential construction of a new cell site. For example, the database 210 may contain field data 302, signal data 304, resources & materials data 306, population data 308, ROI data 310, and any other information associated with the potential construction of a new cell site.

In some examples, the field data 302 can come from workers in the field (e.g., salespeople, land surveyors, technicians, etc.). For example, a sales person may go out into the field to determine the population data 308 associated with a specific region, the need for a new cell site in that specific region, and the reasoning behind the need for the new cell site. In some embodiments, field workers (e.g., employees of a telecommunications network provider, in some examples) may input the resources & materials data 306 into the database 210, and the resources & materials data 306 may include the necessary resources to construct a new cell site. As such, the field data 302 and the resources & materials data 306 may be stored in the database 210 for use by the design component 216 to determine a cell site design 312 of a new cell site.

In some aspects, the signal data 304 may be stored in the database 210 for use by the design component 216. For example, one or more base stations may receive a measurement from each of a plurality of connections to user devices in a specific region, and the measurements associated with those connections may be aggregated to form and/or add to the database 210. By aggregating the connections of user devices within a specific region and storing the information within the database 210 of a wireless communications network, the design component 216 may detect areas of relative service weakness. Notably, areas of relative service weakness are prime locations for a new cell site, and the design component 216 utilizes the aggregated information regarding the quality of service (QoS) of a specific region in making a determination of where a new cell site should be constructed. In some examples, the design component may determine a point-of-presence (POP) (e.g., a point or physical location where two or more networks form a connection from one place to the rest of the internet) to assess the QoS in a specific region.

In some examples, the ROI data 310 includes the ROIs associated with the completed constructions of other cell sites. For example, the ROI data 310 may include the ROI of cell sites built in a geographically defined region, the ROI of cell sites built across the nation, and/or the ROI of constructed cell sites that are similar and/or dissimilar to the cell site design 312 (e.g., after the design component 216 has determined the cell site design 312). In some examples, the design component 216 determines the expected ROI of the cell site design 312 based on all of the data already stored in the database 210 (e.g., the field data 302, the signal data 304, the resources & materials data 306, the population data 308, and/or any other data associated with the construction of a new cell site), and the design component may update the database 210 with the expected ROI associated with the cell site design 312.

As described above, the design component 216 may determine a cell site design 312 based on the data stored in the database 210, including the initial input of how many people may be affected by the new cell site (e.g., the field data 302 and the population data 308), how many new users are likely to be gained (e.g., the field data 302), the type and quantity of materials that will be required to construct the new cell site (e.g., the resources & materials data 306), and the ROI based on the construction of the new cell site (e.g., the ROI data 310). In some embodiments, all of the data that is gathered and stored in the database 210 is readily available to be accessed and processed by the design component 216 in order to determine the cell site design 312, which is suitable for a specific environment given the needs of customers and potential customers located in that environment. For example, building a new cell site in small-town USA that only gains 200 new users may have a lower ROI when compared to building a new cell site in New York City that requires a similar expenditure of resources to gain a greater amount of users (e.g., 1,000 compared to 200, for example). In another example, new users gained by adding a cell site to a rural, small town may only get the basic 5G service, so that new cell site may include a simpler and cheaper design as compared to a new cell site in NYC, which may require a more complex and expensive design due to the constant congestion of traffic, requiring more power and greater service (e.g., such as 6G service). Accordingly, any factor associated with cost, materials, geographic region, speed of construction, and any other aspect relevant in determining the cell site design 312 is weighed and processed by the design component 216 to determine where, when, and how to build a new cell site while at the same time expending the least amount of resources as possible. In other words, the design component 216 may determine a cell site design 312 that is easier to construct, quicker to construct, and cheaper to construct, as compared to other potential cell sites.

As such, the design component 216 processes all of the data stored in the database 210 and determines where, when, and how to build a new cell site based on certain milestones that are necessary and remain to be hit (e.g., obtaining approvals and the timing of the approval process, for example) and the milestones have already been hit (e.g., planning and designing the new cell site). In some embodiments, via an application programming interface (API) 314, users may manually add new data to the database 210 or revise existing data that is already stored in the database 210, thereby updating the database. In some examples, via the API 314, a user may query the project management engine 214, and the project management engine 214 may inform a user (e.g., via the API 314) about the cell site design 312, including when the construction of the new cell site is anticipated, where the new cell site will be constructed, and how the new cell site should be built. Accordingly, users may query the project management engine 214 to receive answers as to the construction process, including the completed steps (e.g., milestones), how the completed steps were executed, the remaining steps, and how to execute the remaining steps.

Turning now to FIG. 4, an example of an approval component system 400 is provided. The approval component system visually illustrates the approval component 218 (e.g., a neural network) communicating to third parties 404 at least one message seeking one or more approvals to begin construction of a new cell site. In the example embodiment depicted in FIG. 4, the approval component 218 communicates messages (e.g., requests for approvals) based on milestones 402 and the data stored in database 210. In some aspects, the milestones 402 include each step and substep that must be completed in order to construct a new cell site. In some examples, the database 210 may be updated with the milestones 402 that are completed and still need to be completed, including determining a design of a new cell site and facilitating the actualization (e.g., construction) of the new cell site. Each cell site could have hundreds of milestones that must be achieved to facilitate the complete construction of the new cell site from beginning to end.

In some embodiments, the approval component 218 processes the milestones 402 and the data stored in the database 210 to request approvals to begin construction. In some examples, the approval component 218 may communicate messages (e.g., the requests for approvals) to third parties 404 (e.g., requesting external approvals) and/or to people who work in-house 406 (requesting internal approvals). In other words, the approval component 218 may request, send, and process paperwork in order to facilitate the acquisition of appropriate approvals to commence construction of a cell site. For example, the approval component 218 may send construction drawings, such as blueprints, to acquire approval by the jurisdiction in which the proposed cell site construction would take place, or the approval component 218 may request drawings from engineers and/or architects who completed the drawings. In some aspects, the approval component 218 sends a message, whether the message be in an electronic format (e.g., such as email, text message, etc.) or in a physical format (e.g., written notice/request printed on paper and ready to be mailed to the source).

As such, the approval component 218 of the project management engine 214 may automate the sending of messages. In some aspects, the approval component 218 may request approvals by sending out automatic messages (e.g., either directly through email or indirectly by printing out the requests for manual delivery, such as a mailing service). Examples of requests for approvals include, but are not limited to, sending out an automatic email for bids for construction projects (e.g., to the general contractors—third parties 404 who actually go out to the construction site and build the cell site), scheduling meetings with contractors, and documenting conversations with contractors; emailing landlords to get approval, to purchase land; contacting the jurisdiction to get approvals and/or permits to commence construction; and figuring out pricing/cost and approving the numbers with accounting (e.g., a communication sent to people who work in-house 406).

The automated messages sent by the approval component 218 may be tailored to the specific milestone that needs to be achieved (e.g., the specific approval that is required to be obtained). For example, when communicating messages to general contractors that seek bids for construction, the automated message could say that construction of the new cell site is anticipated to begin in 2 months, certain materials are anticipated to be used in the construction, and the construction of the cell site should take 3 months (e.g., determined by the design component 216). In this example, the general contractors may respond by accepting the job and/or requiring further details about price and compensation. In some aspects, the approval component 218 may store any response received from the third parties 404 and/or the people who work in-house 406 in the database 210, and a user may review the responses stored in the database 210 via the API 314. For example, a user may review any response received from a general contractor and confirm that the general contractor has been secured for the construction job or that further communication with the general contractor must be had.

In some examples, the approval component 218 may communicate requests for approvals in distinct orders. In some aspects, milestones 402 may run in parallel (e.g., requesting numerous bids for construction from several contractors, for example), and other milestones 402 may depend on the completion of previous steps (e.g., sending an acceptance to one of the bids of construction after receiving and processing the bids). For example, steps A and D (e.g., separate milestones 402) may run in parallel to one another and are processed accordingly (e.g., automatic emails are sent concurrently by the approval component 218 to satisfy both steps A and D). In this example, once steps A and D are completed, the completion of those steps and the data associated with the completions will be documented (e.g., saved in the database 210), then other steps may be completed based on the completion of steps A and D, such as the completion of step B or C. Accordingly, the approval component 218 may manage information for a user, storing the information in the proper location (e.g., the database 210) for the user to access and understand (e.g., via API 314), and the approval component 218 may continue to manage and store information for the user (e.g., until all of the milestones 402 are achieved and/or until the construction of the cell site has concluded). In some embodiments, the approval component 218 applies some sort of threshold to determine whether a message should be sent. For example, if step B can only occur after step A has been completed, the completion of step A may serve as a threshold to the occurrence of step B. As such, the approval component 218 maintains and satisfies a checklist of items (e.g., the milestones 402) that are necessary in order to obtain all of the approvals that are required to commence construction of the new cell site.

In some examples, when the approval component 218 requests a response from a source, the response must be processed to proceed with obtaining further approvals. In some aspects, as long as the subject line (e.g., of an email) or any other common identifier is uniformly used on the face of the communications (e.g., the requests sent by the approval component 218), then all of the communications may be stored in the database 210, retrieved by a user, and processed for further action (e.g., viewed by a user, or used by the project management engine 214 to complete other tasks). For example, the subject lines of email requests that are sent by the approval component 218 could be unique so that any response to the message may be searched by a user to determine if approval has been granted or if further information is needed. In another example, if a request for construction drawings is sent, and construction drawings are received in the response, the approval component 218 may utilize that information when sending out another request to the landlord, the form containing information regarding the construction drawings. In this example, the approval component 218 may also send the construction drawings to any other source for any type of approval pertaining to the construction of the cell site, or the approval component 218 may process any response received from the landlord regarding the initial communication. In some examples, the approval component 218 may schedule meetings between personal (e.g., in-house 406 decision makers, for example) to determine pricing and cost of construction.

As such, as information comes in and out, as requests are received and responded to, the approval component 218 may automatically reply to the responses and/or be capable of informing a user (e.g., via the API 314) that a response has been received and that the user should review the response. Accordingly, the approval component 218 may update the database 210 (e.g., with the information related to the responses regarding the approvals), filter through the data, categorize the information associated with the data, and provide it to a user via a system of record, which tracks the approvals and the steps taken to acquire the approvals (e.g., the milestones 402).

Instead of using human time and resources, the approval component 218 automates sending the messages that are necessary to require the requisite approvals for the specific design of a cell site. For example, if a new cell site must be designed with radio frequency (RF) capabilities, the approval component 218 may send an automated message to all of the sources that need to know that the planned cell site includes an RF design. In another example, the approval component 218 may request a drone flight to be scheduled and completed on the planned property, may request construction drawings, and/or may request any other information related to the procurement of approvals from necessary sources, whether internal (e.g., in-house 406, such as board members, managers, etc.) or external (e.g., third parties 404, such as contractors, jurisdictions, engineers, etc.). By automating the approval process with the approval component 218 of the project management engine 214, the current disclosure makes the process of obtaining approvals more efficient (e.g., reduces human error and unnecessary delays) and less costly.

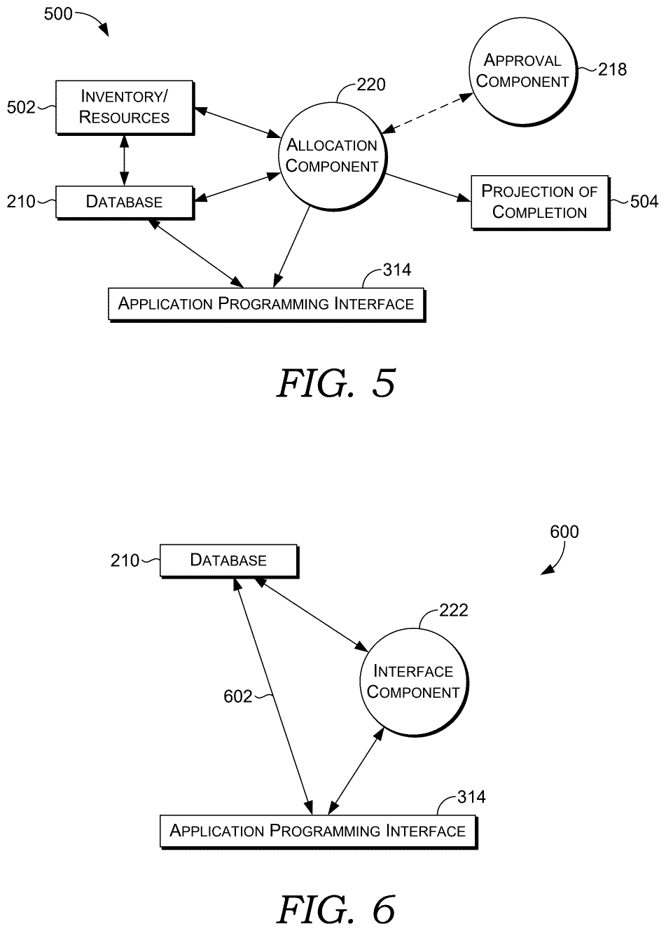

With reference now to FIG. 5, FIG. 5 depicts an example of an allocation component system 500. The allocation component system visually illustrates the allocation component 220 (e.g., a neural network) determining a plurality of resources that are required to complete the construction of a new cell site based on inventory/resources 502 and the data stored in the database 210. In some aspects, the allocation component 220 determines what materials are available (e.g., what materials are in inventory), what other material is still needed, what materials have been used (e.g., if construction has begun), and any other aspect associated with the materials and resources needed to construct the new cell site.

Based on the communications sent out by the approval component 218 and stored in the database 210, the allocation component 220 may determine how to commence construction of a new cell site and how long it may take to complete construction of the new cell site. In some examples, as the approvals are being acquired by the approval component 218 and stored in the database 210, the allocation component 220 may make inferences about how long it will take until the approval process is completed based on historic timelines (e.g., based on completed constructions of other cell sites). The allocation component 220 may be able to determine when construction may commence and how long construction should take based on changing factors. For example, if documents were expected to be received by July 15^{th} during the approval process, but those documents are actually not received until July 30^{th}, then that delay will affect a projection of completion 504. In some examples, a user may obtain the projection of completion 504 via the API 314.

In some aspects, the allocation component 220 of the project management engine 214 may process the inventory/resources 502 based on all of the different needs of the construction that must be fulfilled. In some examples, the allocation component 220 may determine when materials get sent out to the construction site to commence and/or continue construction of the new cell site. In some embodiments, if there is an inventory issue, the allocation component 220 may attempt to correct that issue or determine the next best approach in the construction process. For example, if a necessary part is missing from the inventory that is required to facilitate construction of a first cell site, then the allocation component 220 may determine to pause the building of the first cell site by a certain amount of time (e.g., by two weeks, for example) and instead to prioritize the building of a second cell site. In this example, the allocation component 220 may be able to determine that the missing part required for construction of the first cell site may be obtained in two weeks, and the second cell site is ready to be built in the present moment (e.g., the construction is approved and all of the materials and builders are allocated and available), so the allocation component 220 may recommend to a user that construction of the second cell site should commence/continue while waiting for the missing part to come in to continue at the first cell site. In such a scenario, where construction of one cell site must be paused and construction of another cell site should commence, the allocation component 220 may communicate with the approval component 218 to ensure that the approval component 218 may obtain or has obtained the requisite approvals for construction of the second cell site to start commencing construction of the second cell site.

Similar to the approval component 218, the allocation component 220 also processes and stores the milestones to make a determination (e.g., the projection of completion 504). While the approval component 218 processes communications (e.g., messages seeking approvals) and milestones (e.g., the approvals obtained and still required to be obtained), the allocation component 220 may track communications (e.g., messages seeking the status of materials and progress regarding the construction of the new cell site) and milestones (e.g., the progress related to constructing the new cell site). In some aspects, the allocation component 220 may process and store (e.g., in the database 210) the data associated with the milestones, so that the stored information can be used at a later time by the project management engine 214 and/or a user of the material allocation system. As such, the allocation component 220 may monitor the progress of the construction of the new cell site and record the progress.

With reference now to FIG. 6, FIG. 6 depicts an example of an interface component system 600. The interface component system visually illustrates the interface component 222 (e.g., a generative AI) generating one or more responses to one or more queries related to the status of the construction of a new cell site. In some aspects, the interface component 222 may process all of the data associated with the other components (i.e., the design component 216, the approval component 218, and the allocation component 220), which is stored in the database 210, and the interface component 222 may respond to queries related to information associated with the completed operations of the other components (e.g., the design of a new cell site, the approvals acquired for the new cell site, and the allocation of materials for the new cell site).

In some aspects, the interface component 222 interacts with the API 314, which allows a user to input a query regarding the building of a new cell site (e.g., via a screen or other interface, for example). In some examples, the interface component 222 receives the query, processes the query, retrieves any information related to that query from the database 210, and generates a response to the query. In some embodiments, the responses generated by the interface component 222 may also be saved into the database 210, thereby updating the database 210 with the response for later retrieval and use by the project management engine 214. In some examples, a user may manually update the responses generated by the interface component 222 and store the updated response into the database 210 (e.g., represented by double arrow 602). In some embodiments, the interface component 222 may be used to write to the database 210 itself (e.g., represented by the double arrow 602). For example, a request for an approval may be responded to via an email that does not have the nomenclature (e.g., a proper subject line in the email) required for the approval component 218 to automate a reply to the received response. In this case, the interface component 222 may be used by a user to correct the nomenclature (e.g., subject line) via the API 314 so that the email may be properly stored in the database 210 and relied on for further automation of processes and/or to answer queries received from users.

In some embodiments, all of the information associated with the completed operations of the other components is stored in the database 210, and the interface component 222 employs a large language model to process any language associated with the completed operations of the other components in order to generate responses to queries that pertain to the status of a cell site. As such, the database 210 may updated with a status of construction, wherein the status of construction comprises information associated with the construction of the new cell site. For example, a user may input a query through the API 314 that requests the timeline of when construction of the cell site is anticipated to be completed, and the interface component 222 may respond with the anticipated timeline at that moment (e.g., the timeline may be adjusted as new data comes in). In another example, a user could inquire about how much copper was used in the construction of the cell site, and the interface component 222 could generate a response that reflects the amount of copper used in the construction process. In yet another example, a user may input a query requesting the ROI on a specific cell site (e.g., built, in the process of building, and/or planning to be built). In another example, a user my request the planned allocation of materials within the next week during the construction process of a cell site. Accordingly, all of the data and the progress of the construction of a cell site can be stored in the database 210 and can be retrieved by the interface component 222 and used as input data in order for the interface component 222 to generate an output based on the input data.

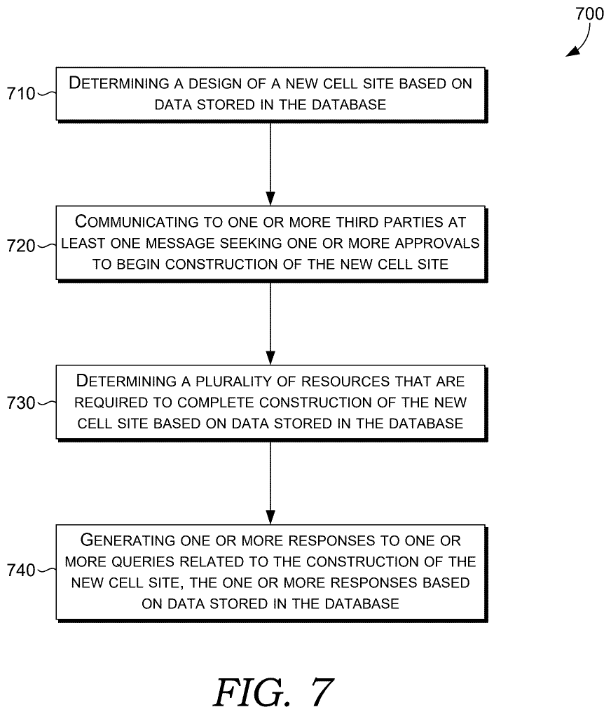

Turning now to FIG. 7, a flow chart representing a method 700 is provided. Generally the method 700 may be used by a network, such as network 208 of FIG. 2, to generate project management attributes within a material allocation system. At a first step 710, the network determines a design of a new cell site based on data stored in a database, according to any one or more aspects described with respect to FIGS. 2-3. At a second step 420, at least one message is communicated to one or more third parties seeking one or more approvals to begin construction of the new cell site, according to any one or more aspects described with respect to FIGS. 2 and 4. At a third step 430, it is determined that a plurality of resources are required to complete construction of the new cell site based on data stored in the database, according to any one or more aspects described with respect to FIGS. 2 and 5. At a step 440, one or more responses to one or more queries related to the construction of the new cell site is generated, and the one or more responses are based on data stored in the database, according to any one or more aspects described with respect to FIGS. 2 and 5.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for generating project management attributes within a material allocation system, the system comprising:
one or more base stations receiving a measurement from each of a plurality of connections and aggregating the measurements to form a database within a wireless communications network to detect areas of relative service weakness; and
one or more computer processing components configured to perform operations comprising:
determining a design of a new cell site based on data stored in the database;
communicating to one or more third parties at least one message seeking one or more approvals to begin construction of the new cell site;
determining a plurality of resources that are required to complete construction of the new cell site based on data stored in the database; and
generating one or more responses to one or more queries related to the construction of the new cell site, the one or more responses based on data stored in the database.

2. The system of claim 1, wherein a neural network determines the design of the new cell site, communicates the one or more documents to the one or more third parties, and determines the plurality of resources required to complete construction of the new cell site.

3. The system of claim 2, wherein the data stored in the database further comprises field data, population data, data associated with a plurality of resources, data associated with a plurality of materials, and data associated with a return on investment.

4. The system of claim 2, wherein determining the design of the new cell site further comprises determining when to begin construction of the new cell site, where to construct the new cell site, and how to construct the new cell site.

5. The system of claim 2, wherein the data stored in the database is updated with a status of construction, wherein the status of construction comprises information associated with the construction of the new cell site.

6. The system of claim 2, wherein the at least one message is based on the design of the new cell site.

7. The system of claim 2, wherein the at least one message comprises an automatic email.

8. The system of claim 2, wherein a generative artificial intelligence (AI) generates the one or more responses to the one or more queries.

9. The system of claim 2, wherein an application programming interface (API) is used to cause display of the one or more responses to the one or more queries.

10. A method for generating project management attributes within a material allocation system, the method comprising:
determining a design of a new cell site based on one or more base stations receiving a measurement from each of a plurality of connections and aggregating the measurements to form a database within a wireless communications network to detect areas of relative service weakness;
communicating to one or more third parties at least one message seeking one or more approvals to begin construction of the new cell site;
determining a plurality of resources that are required to complete construction of the new cell site based on data stored in the database; and
generating one or more responses to one or more queries related to the construction of the new cell site, the one or more responses based on data stored in the database.

11. The method of claim 10, wherein a neural network determines the design of the new cell site, communicates the one or more documents to the one or more third parties, and determines the plurality of resources required to complete construction of the new cell site.

12. The method of claim 11, wherein the data stored in the database further comprises field data, population data, data associated with a plurality of resources, data associated with a plurality of materials, and data associated with a return on investment.

13. The method of claim 11, wherein determining the design of the new cell site further comprises determining when to begin construction of the new cell site, where to construct the new cell site, and how to construct the new cell site.

14. The method of claim 11, wherein the data stored in the database is updated with a status of construction, wherein the status of construction comprises information associated with the construction of the new cell site.

15. The method of claim 11, wherein the at least one message comprises an automatic email.

16. The method of claim 11, wherein a generative artificial intelligence (AI) generates the one or more responses to the one or more queries.

17. The method of claim 11, wherein an application programming interface (API) is used to cause display of the one or more responses to the one or more queries.

18. A non-transitory computer readable media having instructions stored thereon that, when executed by one or more computer processing components, cause the one or more computer processing components to perform a method for generating project management attributes within a material allocation system, the method comprising:
determining a design of a new cell site based on one or more base stations receiving a measurement from each of a plurality of connections and aggregating the measurements to form a database within a wireless communications network to detect areas of relative service weakness;
communicating to one or more third parties at least one message seeking one or more approvals to begin construction of the new cell site;
determining a plurality of resources that are required to complete construction of the new cell site based on data stored in the database; and
generating one or more responses to one or more queries related to the construction of the new cell site, the one or more responses based on data stored in the database.

19. The non-transitory computer storage media of claim 18, wherein a neural network determines the design of the new cell site, communicates the one or more documents to the one or more third parties, and determines the plurality of resources required to complete construction of the new cell site.

20. The non-transitory computer storage media of claim 19, wherein a generative artificial intelligence (AI) generates the one or more responses to the one or more queries.
